(19) United States
(12) Patent Application Publication
(10) Pub. No.: US 2021/0271719 A1
(43) Pub. Date: Sep. 2, 2021

(54) CONSOLIDATED DOCUMENT GENERATION

(71) Applicant: Hewlett-Packard Development Company, L.P., Spring, TX (US)

(72) Inventors: Sophie Shadi Lejeune, Sant Cugat del Valles (ES); Ana Maria Cardells Tormo, Sant Cugat del Valles (ES); Sergi Gilabert Ferrer, Sant Cugat del Valles (ES)

(73) Assignee: Hewlett-Packard Development Company, L.P., Spring, TX (US)

(21) Appl. No.: 17/261,193

(22) PCT Filed: Sep. 28, 2018
(86) PCT No.: PCT/US2018/053378

§ 371 Date: Jan. 19, 2021

(51) Int. Cl. G06F 16/93; G06F 40/166; G06K 9/00

(52) U.S. Cl. CPC G06F 16/93; G06K 9/00483; G06F 40/166

(57) ABSTRACT

A method of generating a consolidated document is described. In some examples, the method comprises obtaining a plurality of documents, and identifying one or more portions that are different between the documents. One or more properties of the portions are adjusted to generate adjusted portions; a consolidated document is generated using the adjusted portions and the documents. In the consolidated document each of the documents documents is associated with a layer, and a composite layer is constructed layer from respective layers within the consolidated document.

### BACKGROUND

During a project such as a building renovation, restoration and/or construction project, hardcopy versions of drawings of an existing area and/or building may be used to indicate particular architectural features and/or specifications. As the project progresses, modifications may need to be made to the drawings to indicate changes or revisions to the specifications of the project. In order to make these amendments, the drawings may need to be digitized so that they are able to be reused and amended. In such a case each drawing may be created, for example by taking all measurements on site, or alternatively an existing drawing can be scanned into an appropriate program and revised using the scanned image as a background. During the lifespan of the project, the drawings may be revised, therefore this process may be repeated a number of times.

### BRIEF DESCRIPTION OF THE DRAWINGS

Various features of the present disclosure will be apparent from the detailed description which follows, taken in conjunction with the accompanying drawings, which together illustrate features of the present disclosure, and wherein:

FIG. 1 is a flow diagram illustrating a method for generating a consolidated document according to an example;

FIG. 2 is a schematic diagram of a processing device arranged to generate a consolidated document according to a first example;

FIG. 3 is a schematic diagram showing a processing device arranged to generate a consolidated document according to a second example;

FIG. 4A is first view of an output rendered on a display screen when a program executes, the output shows the consolidated document of the method of FIG. 1;

FIG. 4B is a second view of an output rendered on a display screen when a program executes, the output shows the consolidated document of the method of FIG. 1; and

FIG. 4C is a third view of an output rendered on a display screen when a program executes, the output shows the consolidated document of the method of FIG. 1.

Throughout the Figures, like reference numerals are used to denote like features.

### DETAILED DESCRIPTION

In the following description for the purpose of explanation, numerous specific details of certain examples are set forth. Reference in the specification to ‘an example’ or similar language means that a particular feature, structure, or characteristic described in connection with the examples is included in at least that one example, but not necessarily in other examples.

Throughout a project, documents are created to assist professionals, such as architects, structural engineers, or construction workers. During the lifespan of the project the documents may be amended, adjusted and otherwise altered to change features and/or specifications of the project. For example, during a building refurbishment, original plans of the building may be used, and subsequently altered to show the amendments or additions to be added or areas to be removed during the refurbishment.

For buildings which have been renovated or refurbished numerous times, it may be beneficial for professionals to have access to plans from all previous projects on that particular site. Accordingly, it may also be beneficial for the professionals to have access to each of the different plans from previous projects to show how the building has been altered over time. Similarly, as the project progresses it may be beneficial for the professional to access each version of the document created, this allows revisions made throughout the project to be identified by the professional. In other examples, it may also be beneficial to be able to readily access the previous versions of a document, for example documents showing the evolution of the design of a new product, or documents containing medical scan information. Being able to readily visualize differences between versions of these documents enables a viewer to track the progress and see the variation between the different versions.

Over the course of a project, documents may be altered a large number of times, resulting in numerous different documents for each iteration of the design. Managing these documents can be cumbersome and may lead to an incorrect version being used as a main document, even though a more up-to-date version exists.

Detecting changes between the different versions of the documents is also a time-consuming task. For example, a professional would look over two versions of the document and manually detect any changes, which would then need to be recorded in a separate document. Further complications may occur if the professional does not have access to all relevant documents, for example the change that the professional detects may, in fact, have occurred in a previous version of the document from earlier in the project

In one example, a structural engineer working on a project for the restoration or construction of a new area/building may begin the project with a hard copy plan showing the present condition of the building/area. These plans would need to be digitized to be reused throughout the project.

A professional, such as an architect, may first attend the site and measure the features needing to be displayed on the plan. The professional would then redraw the plan digitally using a computer aided design (CAD) program. Alternatively, the professional may choose to scan the plan for use as a background, then redraw over the plan using a CAD program. Both these options are time consuming and may result in errors being introduced due to copying and/or measurement mistakes.

Throughout the course of the project, other versions of the document may be created, each having their own amendments. Therefore, as the project progresses any errors in any given version will propagate through each subsequent version. Similarly, if the project is a continuation of a previous project where there have been a number of versions of a document created, the professional may need to incorporate the changes made in each of those versions of the documents prior to starting the new project, thereby increasing the opportunity for errors to be made as well as being time consuming.

Having separate documents for each version means that the amount of paperwork and storage space needed is non-trivial. At the end of the project, a client or customer of the professional may wish to have copies of the documents. Collating, packaging and sending all the versions of the documents, and indicating the differences between the plans is time consuming and costly.

To avoid these issues, an example method for generating a consolidated document, as described herein, provides a way of generating a document containing different versions and capable of indicating changes between the versions.

An example method comprises obtaining a plurality of documents; identifying one or more portions that are different between the documents; adjusting one or more properties of the portions to generate adjusted portions; and generating a consolidated document using the adjusted portions and the documents; wherein generating the consolidated document comprises associating each of the plurality of documents with a layer, and constructing a composite layer from respective layers within the consolidated document.

The plurality of documents may correspond to one or more iterations of a plan for use in a building construction or renovation project; medical scans, for example versions of a computerized tomography (CT), magnetic resonance imaging (MRI), or X-ray scans taken at different stages throughout a patient's treatment; and/or schematic drawings showing the evolution of a product throughout the different stages of the design lifecycle.

For example, the plurality of documents may relate to one or more iterations of a plan for use in a building construction or renovation project, a first plan may represent the construction site area, or current buildings presently occupying said site, and a second plan may represent a first iteration of the design. Subsequent plans may represent further iterations of the design, wherein portions of the first iteration have been amended, added to, or removed from the plans.

Similarly, where the plurality of documents relate to one or more versions of a medical scan of a patient, a first version may be a scan of the patient at the beginning of their treatment, and subsequent scans may represent scans taken throughout the course of the treatment to indicate the progression or regression of a particular ailment.

As another example, where the plurality of documents relate to schematics showing the design process of a particular product, a first document may represent the initial idea for the product, and subsequent schematics may represent each of the iterations of the design as the product progresses to manufacture.

Identifying portions or parts which differ between each version of the document enables a viewer to readily identify what has changed between the versions of the documents as the project progresses. For example, the method may identify differences between a first version of a document and a second version of a document, and then identify further differences between the second version of a document and a third version of a document.

In an example, a property of each of the identified features may be adjusted. For example, a line color or line style may be altered enabling a viewer to readily identify the differences. Furthermore, differences between, for example, a first and second version, and a second and third version, may have their properties adjusted in different way. In such an example, a viewer would be able to identify differences between the first and second documents and the second and third documents and also identify at which stage in the project said amendments were made.

By combining each of the versions of the document into a single consolidated document, with a number of layers and a composite layer, the number of documents a professional has to manage is reduced. This also allows the professional to readily identify changes made to the documents between the versions. In the consolidated document, each version of a document is associated with one of the number of layers, and the composite layer comprising all versions of the document wherein the identified portions each have the adjusted properties mentioned above.

In another example, the versions of the documents may be digitized by scanning them into a computing device. The computing device may remove any background artifacts from the scanned documents, and then in some examples, the documents may be converted into vector documents by detecting the line and text components making up the document. By removing background artifacts and converting the document into a vectorized image, individual component parts of the document may be selected and/or compared more efficiently.

In some examples, the documents may need to be aligned so that on formation of the consolidated document, corresponding components of the documents are correctly positioned. Aligning the documents may be achieved, for example, by applying one or more transformations to the documents, such as a scale, rotation, or skew transformation.

In a further example, portions or parts which are common to the documents may also be detected. For example, in the vectorized documents, portions which appear in all documents may be designated as common, and then a property of those portions may also be adjusted to differentiate the common portions from portions which change throughout the documents. To differentiate between the detected portions, including those portions which differ throughout the plurality of documents, and those portions which remain constant throughout the plurality of documents, in some examples, the properties of the portions may be altered and/or adjusted. For example, lines of a vectorized document which are determined to be different from a previous version of the document may have their color, line style, and/or thickness altered. Although it will be appreciated that other properties may also be altered.

In some examples, where it is to be indicated that a portion appears in one version of a document but not another, the color of said portion may be adjusted to differentiate it from other portions within the document. Similarly, in a further example, where it is to be indicated that a portion appears in all versions of a document, the thickness of the lines making up that portion may be adjusted. Therefore, when the plurality of documents are combined into the composite layer, the viewer will be able to identify which portions of the image are present throughout all versions of the document., and which portions are associated with each of the plurality of documents.

In yet a further example, optical character recognition (OCR) may be used to determine a name for each of the layers within the consolidated document. For example, each of the plurality of documents may contain an identifying mark which indicates to a viewer which version of the document it represents. OCR may be used to recognize this mark and name the layer in the consolidated document appropriately.

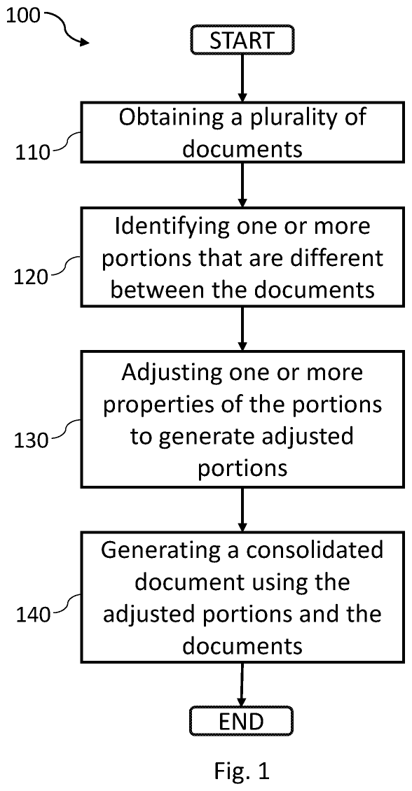

FIG. 1 is a flow diagram illustrating a method 100 for generating a consolidated document. At block 110, a plurality of documents are obtained. The documents, as described previously, may be representative of different versions of a single document, such as a plan of a building undergoing renovations. Next at block 120, portions that differ between the documents are identified. In an example, where the documents are not vector images, an additional block (not shown) for vectorizing the documents may be utilized. In this vectorization block, background artifacts within the documents may be identified and removed, and the remaining components of the document may be converted to a vector document.

Converting the document to a vector document enables each feature of the vector document to be compared to features in another vectorized version of the document, in order to identify which, if any, features have been modified, added to and/or removed from the earlier document. The features may include lines, polygons, circles, or other shapes.

Once the differing portions or parts have been identified, at block 130 one or more properties of the differing portions are adjusted. For example, portions which differ between a first and second version of the document may be adjusted so that they have a first color, and portions which differ between a second and third version of the document may be adjusted so that they have a second color. In some examples a further block (not shown) may be implemented to detect common portions between the documents and adjust the properties of the detected common portions, for example by adjusting the color, line style or thickness of the common portions so that they may be differentiated from the differing portions. Examples of lines styles may be, e.g., dashed lines, lines with interleaved dots, double lines, etc.

At block 140, a consolidated document is generated. The consolidated document, for example, comprises a plurality of layers and a composite layer. The composite layer contains the adjusted portion information for representing the differences between the plans. Each of the versions of the document are associated with a layer within the consolidated document, enabling all versions of the document to be accessed from within a single file, and providing the viewer with the ability to readily switch between the versions.

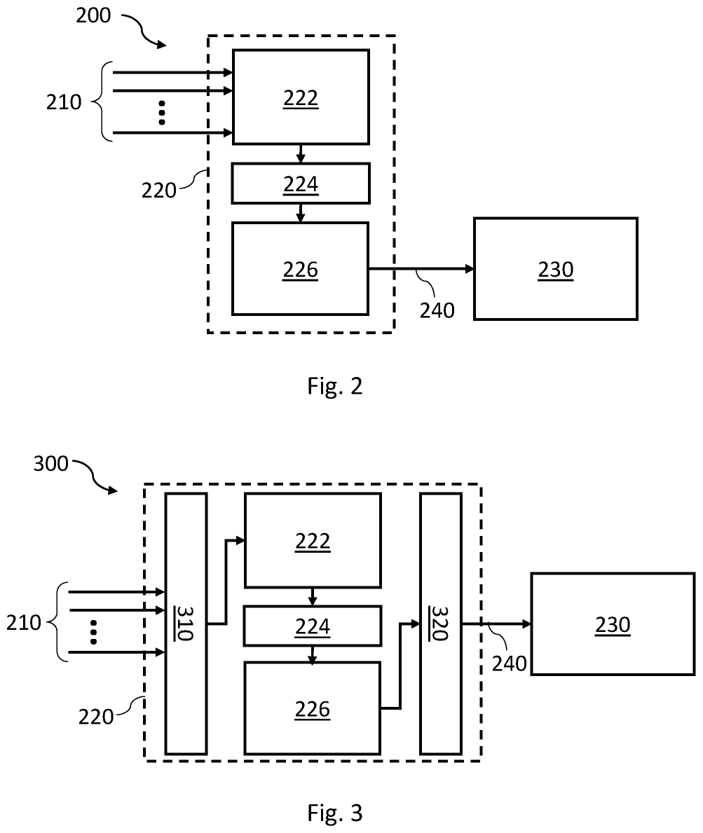

FIG. 2 is a schematic diagram of a processing device 200 arranged to generate a consolidated document according to a first example. The processing device 200 has a processor 220, and storage 230. The processing device 200 is arranged to receive a plurality of documents 210 as an input and produce a consolidated document 240 as an output.

The processor 220 comprises an identification module 222 for identifying one or more differences between the versions of the plurality of documents 210 received as an input. The processor 220 also comprises an adjustment module 224. The adjustment module 224 is arranged to alter, adjust or change one or more properties of the identified differences. For example, the adjustment module 224 may be arranged to modify the color of the lines of the differing portions. Furthermore, where there are multiple versions of the input documents 210 to be processed, the adjustment module 224 may assign one or more particular property changes to each version. For example, the differences between a first version and a second version may be assigned one type of property change, and differences between a first version and a second version may be assigned a second property change. The processor 220 also comprises a generation module 226 for generating the consolidated document 240. The consolidated document 240, as described above comprises a number of layers, one for each of the plurality of documents 210 received as an input and a further composite layer comprising the information associated with each of the adjusted propertied provided by the adjustment module 224. In some examples, the identification module 222 may be arranged to detect common portions between the plurality of documents 210, and the adjustment module 224 may be arranged to alter the properties of the common portions.

The processing device 200 may also comprise a storage medium 230 for storing the composite document 240. The storage 230 may be a random-access memory (RAM) such as DDR-SDRAM (double data rate synchronous dynamic random-access memory). In further examples, the storage 230 may be or include a non-volatile memory such as Read Only Memory (ROM) or a solid-state drive (SSD) such as Flash memory. The storage 230 in examples may include further storage devices, for example magnetic, optical or tape media, compact disc (CD), digital versatile disc (DVD) or other data storage media. The storage 230 may be removable or non-removable from the processing device 200.

The processing device 200 may form part of a system comprising a scanning device, such as a scanner. The scanner may be used to obtain the plurality of documents 210, by successively scanning each of the plurality of documents 210 into a storage, such as storage medium 230. The plurality of documents 210 may then be processed as discussed above.

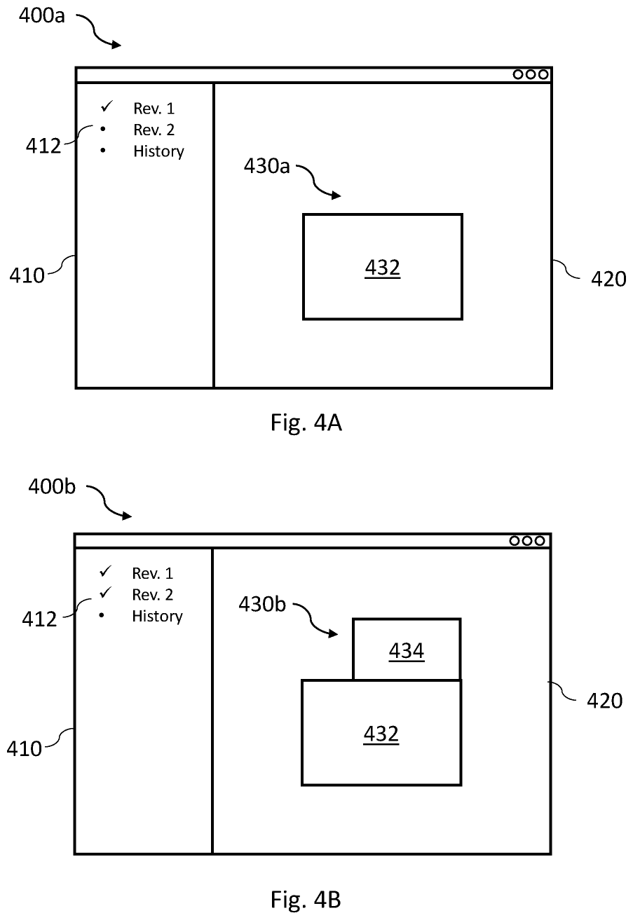

FIG. 3 is a schematic diagram showing a processing device 300 arranged to generate a consolidated document according to a second example. The processing device 300 has a processor 220, and storage 230. The processing device 300 is arranged to receive a plurality of documents 210 as an input and produces a consolidated document 240 as an output.

The processor 220 comprises a vectorization module 310. The vectorization module 310 receives as an input the plurality of documents 210. In some examples the plurality of documents 210 may have been obtained via a scanning device (not shown) arranged to electronically capture one or more of the documents 210. The vectorization module 310 may be arranged to remove background artifacts from any of the plurality of documents 210, and detect lines, shapes and or other features of the documents 210 and convert them into vector documents. The vector documents are then processed by the identification module 222, adjustment module 224, and generation module 226 as described above in relation to FIG. 2.

In some examples, the processor 220 may further comprise a naming module 320. The naming module 320 is arranged to detect one or more identifying marks within the plurality of documents 210. In some examples, the naming module 320 may undertake said detection prior to the vectorization of the documents 210, or as shown in FIG. 3, the naming module may undertake the detection after the generation of the composite document 240 by the generation module 226.

The naming module 320 may be arranged to produce an identifying label for each of the layers in the composite document 240. The label may be based upon the identifying marks detected by the naming module 320, and enable a viewer to identify the layer associated with each of the plurality of documents 210, as well as the composite layer.

As described above in relation to FIG. 2, the consolidated document 240 is then output to storage 230.

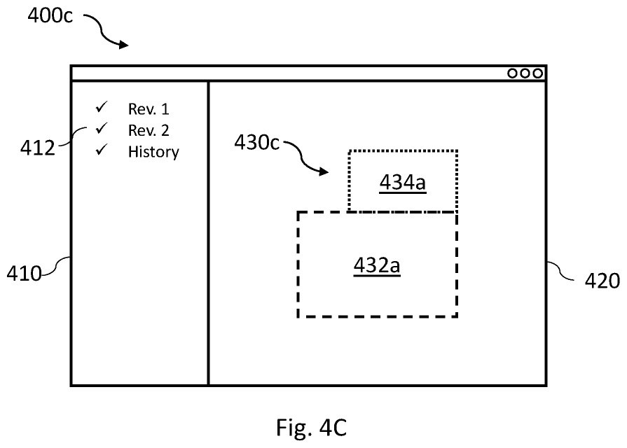

FIGS. 4A, 4B, and 4C show an output rendered on a display screen when a program executes. The program causes a composite document generated by the method of FIG. 1 to be displayed. FIG. 4A shows a first screen 400a. The first view 400a comprises a side panel 410, and a main panel 420. The side panel contains a list 412 displaying each of the layers of a composite document, such as 240 generated by the processing devices of FIGS. 2 and 3 and the method of FIG. 1. Each item in the list 412 is representative of one of the plurality of documents 210 representing the different versions of a document. The list items may be named according to a label generated by a naming module, such as 320 in FIG. 3, which as described above may use OCR to determine an appropriate label based on the contents of the plurality of documents 210.

The main panel 420 displays the contents of one or more layers listed in the list 412. As shown in FIG. 4A, a layer representing a first version of a document 430a is shown in the main panel 420. The first version 430a comprises a portion 432 which, as it is the first version, represents an initial stage of the project. For example, where the project is a building renovation as described above, the first version 430a may represent the initial state of a construction site and/or any pre-existing buildings.

FIG. 4B shows a second view 400b of the output rendered on a display screen when the program executes. The second view 400b shows the side panel 412 with both a first and second option enabled. The main panel 420 displays a second version 430b. The second version 430b comprises the first portion 432, which forms part of the first version 430a, and also a second portion 434 which may be indicative of a change, such as an addition or alteration to the first version 430a. In some examples, where portions have been deleted this may also be indicated in the versions 430a,430b. Where the project is a building renovation, the second version 430b may represent an intermediate version or even a final version of the document, as is the case in the example shown in FIGS. 4A, 4B, and 4C.

FIG. 4C shows a third view 400c of the output rendered on a display screen when the program executes. The third view 400c, as with the first and second views 400a,400b of FIGS. 4A and 4B shows a side panel 412 comprising a list 412 of layers. In the third view 400c the ‘History’ layer is enabled. With the ‘History’ layer enabled, the main panel 420 displays a composite 430c of the different versions of the plurality of documents 210. The composite 430c, as described above comprises all versions of the document 210 where differences have been detected between different portions of the documents 210 and the properties of those portions have been altered. As shown in FIG. 4C, the composite 430c comprises a first portion 432a representative of the first version 430a shown in FIG. 4A, and a second portion 434a representative of the second version 430b shown in FIG. 4B.

The first portion 432a has had the line style altered to a dashed line, and the second portion 434a has had the line style altered to a dotted line. This enables a viewer to efficiently determine what alterations and/or adjustments have been made in each version of the plurality of documents 210. In some examples, the list 412 may also comprise an indicator, legend, or key to assist the viewer in determining which line style represents which version. In other examples, the color of the line may be altered, and therefore each item in the list 412 may be colored to correspond with the line color of the associated revision.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method of generating a consolidated document, the method comprising:
obtaining a plurality of documents;
identifying one or more portions that are different between the documents;
adjusting one or more properties of the portions to generate adjusted portions; and
generating a consolidated document using the adjusted portions and the documents,
wherein:
generating the consolidated document comprises associating each of the plurality of documents with a layer, and constructing a composite layer from respective layers within the consolidated document.

2. The method of claim 1, wherein obtaining a plurality of documents comprises scanning each of the plurality of documents.

3. The method of claim 1, comprising removing background information from each of the documents.

4. The method of claim 1, comprising converting each of the documents into a vector document.

5. The method of claim 1, comprising identifying portions that are common between the documents.

6. The method of claim 6, wherein identifying portions that are common between the documents comprises detecting one or more features which are repeated in each of the documents.

7. The method of claim 1, wherein identifying one or more portions that are different comprises detecting one or more features which appear in one of a first and a second document.

8. The method of claim 1, wherein adjusting one or more properties comprises adjusting the color of one or more features of the documents.

9. The method of claims 6, wherein the features comprise any of lines, polygons, or circles.

10. The method of claim 1, comprising assigning a label to each of the layers.

11. The method of claim 10, wherein the label is generated based upon the contents of the documents.

12. An apparatus for generating a combined document, the apparatus comprising:
storage for storing a plurality of versions of a document;
an identification module for identifying one or more parts that are different between the versions and adjusting one or more properties of the parts; and
a generation module for generating a combined document from the versions and adjusted parts,
wherein:
the generation module associates each of the versions with a layer, and forms a composite layer from respective layers within the combined document.

13. The apparatus of claim 12, comprising a vectorization module for converting the versions into vector drawings.

14. The apparatus of claim 12, comprising a scanning module for obtaining the plurality of versions of the document.

15. A non-transitory machine-readable storage medium encoded with instructions executable by a processor, the machine-readable storage medium comprising:
instructions to collect a plurality of documents;
instructions to identify one or more variances between the documents;
instructions to adjust one or more properties of the variances to produce adjusted variances; and
instructions to generate a consolidated document using the adjusted variances and the documents,
wherein:
the instructions to generate the consolidated document comprise instructions to associate each of the documents with a layer, and to construct a combined from respective layers within the consolidated document.
